(19) United States
(12) Patent Application Publication
(10) Pub. No.: US 2009/0013535 A1
(43) Pub. Date: Jan. 15, 2009

(54) Manual toll for stripping electrical cables and set of tools for stripping said cables

(75) Inventor: Frederic Derancourt, Le Soler (FR)

Correspondence Address: YOUNG & THOMPSON, 209 Madison Street, Suite 500, ALEXANDRIA, VA, 22314, US

(73) Assignee: Derancourt S.A.S., Le Soler (FR)

(21) Appl. No.: 11/792,308

(22) PCT Filed: Dec. 5, 2005
(86) PCT No.: PCT/EP2005/056475

§ 371 Date: Mar. 13, 2008

(30) Foreign Application Priority Data
Dec. 5, 2004 (FR) 0412921

(51) Int. Cl. H02G 1/12

(52) U.S. Cl. 30/90.6

(57) ABSTRACT

A tool for stripping electric cables includes a mount (1) whereon are slidingly mounted two jaw blocks (2, 3) both co-operating with a common mechanism (4) setting their mutual positions, providing a symmetrical positioning of the two jaw blocks relative to a median geometrical plane. The mechanism (4) includes a threaded rod (40) with a maneuvering knob, mounted fixedly in translation and mobile in rotation relative to the mount, the rod having a first right-hand threaded section (401) screwingly engaged in a through female thread provided in one of the jaw blocks and a second left-hand threaded section (402) having a pitch similar to the former section, the second threaded section being engaged in a through female thread provided in the other jaw block.

The present invention is in the field of materials used for preparation, particularly of the ends of cables of buried electrical lines so as to remove for an appropriate length the insulating and semiconducting layers which protect the central electrical conductor.

Typically, this type of cable has about the central metallic core, an insulating layer of synthetic material clad on the internal and external surfaces of the insulating layers of said semiconductors. About the insulating layer is disposed an insulating protective external sleeve. Between the external semiconductor and the external sleeve, the cable is provided with a strip of aluminum.

There are essentially two types of cables: the cables whose external semiconductor is peelable and separable from the insulating layer, and the cables whose external semiconductor cannot be peeled and is inseparable from the insulating layer.

No matter the type in question, the cables, in distribution networks, are conventionally associated in a woven threesome and transport and distribute the tri-phased current, each cable carrying in one of the three phases. Each strand is comprised by a same type of cable.

For the connection of the cables of a first network to a second network, the ends of these cables are stripped to expose the conductive core. This core is then engaged in housings of suitable connectors.

The technical specifications determine the different lengths of stripping. Thus, the conductive core is stripped over a first length, the semiconductive layer over a second length and finally the insulating sleeve over a third length, the stripping taking place in successive steps.

There are already known various tools for preparing the cables. These tools use two opposed jaw blocks each forming a V defining with the V of the other jaw block, a recess into which is introduced the end of the cable to be prepared. These two jaw blocks are mounted on a same frame movably for one and fixedly for the other.

Typically, the movable jaw block is actuated by a mechanism of the screw and nut type, the nut being formed in or carried by the movable jaw block, whilst the screw is carried by the frame. At least one of the two jaw blocks carries a cutting blade projecting into the recess for the cable to cut off the external sleeve or the external semiconductor or the insulating layer surrounding the electrical conductor, by driving in rotation the tool on the cable.

Such tools are known from many patents, of which could be cited for example FR-A-2 121 141, FR-A-2 607 636, FR-A-2 739 503, FR-A-2 736 475.

FR-A-2 121 141 shows a tool to prepare an electrical cable. According to this patent, the cutting blades are mounted on one of the lateral surfaces of the jaw blocks and are held each in position by a gripping screw engaged first of all in a hole passing through the blade and then into a tapping of the block. To adjust the blade in position, and as a result to regulate the depth of cutting, the through hole is arranged as an oblong opening. With such an arrangement, it is difficult to adjust the depth of cutting to a precise value. However, regulations prohibit, during the operation of removing a layer, damaging the layer immediately below, so as to avoid cuts which could be formed, the creation of ruptures in the insulating layers. However, the imprecision of adjustment increases the risk of damaging the insulating layers.

A solution to this problem has been proposed by FR-A-2 607 636 and by FR-A-2 739 503.

In the tool according to FR-A-2 607 636, which is adapted specifically for removing the external insulating layer, the cutting blade is associated with a micrometric adjustment mechanism and the block which carries it is provided with a projection comprising a flat bearing surface for the cable, the blade forming a projection relative to this surface. However, the cutting blade is fixed on the block by a set screw whose drawback is that it can become unscrewed in the course of use, thereby giving rise to modification of the depth of the cut.

The tool according to FR-A-2 739 503 has an indexing system for the cutting blade carried by the V-shaped jaw of the tool. Such a system permits adjustment of the projection of the blade in the V and the adjustment of the inclination of this latter. Such a system, although it avoids involuntary modification of the depth of the cutting blade in the V, however does not permit keeping without modification of the adjustment, a same value of depth of cutting into the cables of different diameters, this by reason of the fact that the degree of sinking of the cable into the V of the jaw depends only on its diameter. This tool is principally adapted for removing external sleeves and insulating layers.

FR-A-2 736 475 relates to a tool with which it is possible to carry out successively several complementary operations on the cable. Thus, with this tool, it is possible to carry out successively the removal of the external sleeve, the removal of the external peelable semiconductor and the removal of the insulating layer. For removing the external non-peelable semiconductor, use is made of an auxiliary tool. In the case of acting by two persons on a same strand or on two separate cables to be connected to each other, which is often the case, one of these two persons should wait until the other has completed his work with the help of this tool before undertaking his own.

However, to reduce the duration of the intervention, several tasks should be undertaken simultaneously, for example an operation of removing the external sleeve on one of the cables and an operation of removing the peelable or non-peelable semiconductive layer on the other cable.

There is also known from FR 2 763 272 a tangential cutting tool for optical tubes or cables.

Another common drawback for the different tools resides in the fact that the positioning of the jaw blocks on the cable poses problems, this positioning taking place in too slow a manner according to users.

Still another drawback common to these different tools resides in poor distribution of the weights relative to the recess for the cable, which translates into poor ergonomy during use of the tool.

Finally, for certain tools, the jaw blocks are secured to each other by three or four columns distributed on opposite sides of the passage of the cable formed in the two jaws. This arrangement results in the impossibility of engaging the tool on the cable by radial movement.

The present invention has for its object to solve the preceding drawbacks cited above by using a tool for stripping electrical cable comprising a frame on which are installed two jaw blocks coacting with each other with a same adjustment mechanism for their mutual positions, at least one of the two blocks being provided with a V-shaped groove defining with the other jaw block a recess for the cable to be stripped and at least one of the two blocks being provided with at least one cutting blade, said tool being characterized essentially in that:
the frame comprises two parallel columns rigidly connected at the end by two crosspieces, these two columns and these two crosspieces forming a rigid frame,
the two jaw blocks are mounted slidably on the two columns and are disposed symmetrically relative to a geometric plane P central to the frame and orthogonal to the columns of this latter,
the two jaw blocks are disposed both on the same side of the frame defined by the two columns and the two crosspieces,
and the adjustment mechanism for the position of the two jaw blocks, which ensures a symmetrical position of the two jaws relative to the geometric plane defined above, comprises a screw-threaded rod with a manipulating knob, extending parallel to the columns between the two crosspieces, said screw-threaded rod being immovable in translation and movable in rotation relative to the frame and comprising a first screw-threaded section with a right-hand thread engaged by screwing in a through tapping provided in one of the jaw blocks, and a second screw-threaded section having a left-hand thread and of the same value as that of the preceding section, said second screw-threaded section being engaged in a through tapping provided in the other jaw block.

Thanks to these characteristics, the weights will be distributed in a symmetrical manner on opposite sides of the geometric plane P.

There are thus diminished the parasitic forces due to poor distribution of weights, which parasitic forces which unbalance the tool about the cable.

Moreover, the double thread which the screw-threaded rod has, permits a rapid movement of the two jaws and as a result a more rapid replacement of the tool on the cable.

Moreover, as the jaws are located on a single side of the frame, the introduction of the cable between these latter can be carried out by radial movement and no longer only by axial movement.

According to a first embodiment of the tool according to the invention, one of the two jaw blocks is provided with a cutting blade and this latter is configured for removing the external insulating sleeve and its limiting strip and for the withdrawal of the insulating layer and of the associated internal semiconductive layer.

According to another characteristic of the tool according to this first embodiment, the other jaw block is provided with a cutting blade adapted for the formation of a chamfer at the insulating end.

According to a second embodiment of the tool according to the invention, one of the two jaw blocks is provided with a blade adapted for removing the peelable external semiconductive layer and the opposite jaw block is provided with a cutting blade adapted for removing the non-peelable external semiconductive layer.

The present invention also has for its object a set of tools for carrying out the operations of preparing the ends of electrical cables, this set of tools being essentially characterized in that it comprises a tool according to the first embodiment and a tool according to the second embodiment.

Thus with the set of tools according to the invention, two users can work simultaneously on various cables to be connected, the second user after the first having withdrawn the external insulating sleeve from the first cable, can then act on this first cable for withdrawing the semiconductive layer. During this time, the first user can act on the second cable again for removing the insulating external layer. While the second user acts on the second cable for withdrawing the semiconductive layer, the first user can again act on the first cable this time for removing the insulating layer, and so on.

It will be understood that several operations can thus be carried out simultaneously on several cables, which decreases the time of operation.

Other objects, advantages and characteristics of the invention will become apparent from a reading of the description of a preferred embodiment, with reference to the accompanying drawings, in which:

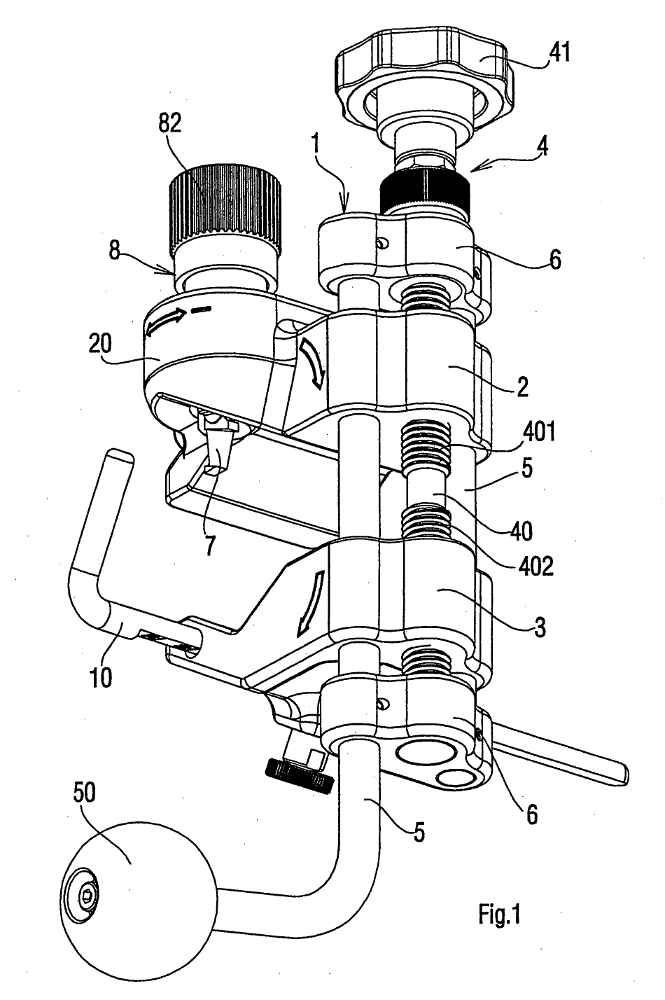

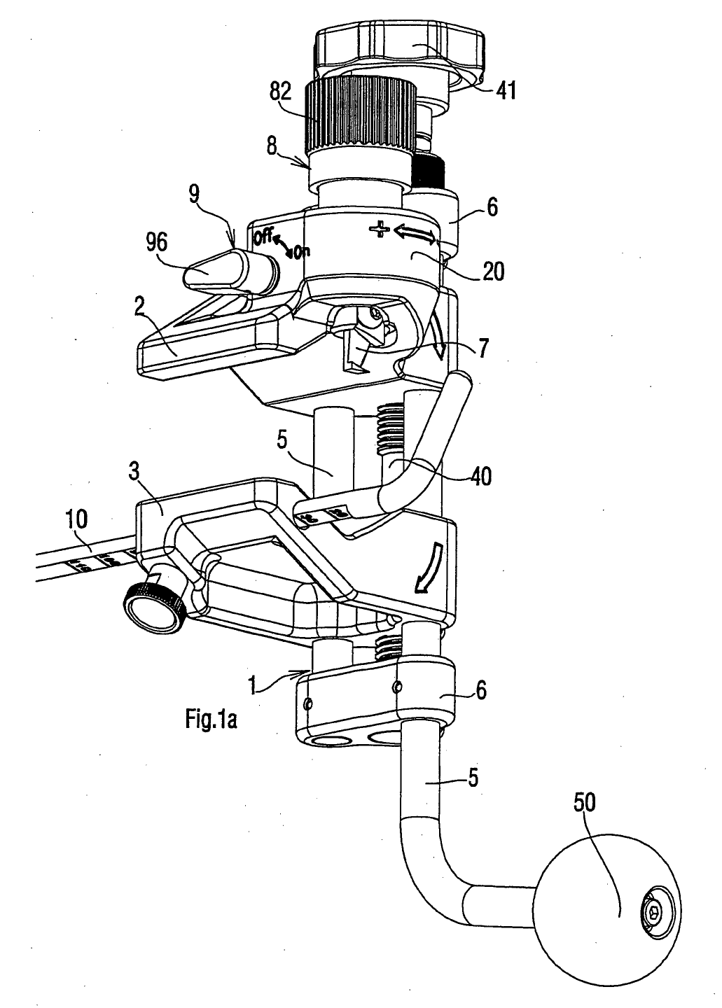

FIG. 1 is a perspective view of a first embodiment of a tool according to the invention, specifically adapted for removing the external insulating sleeve and the internal layer.

FIG. 1a is a perspective view of the tool from another angle of view,

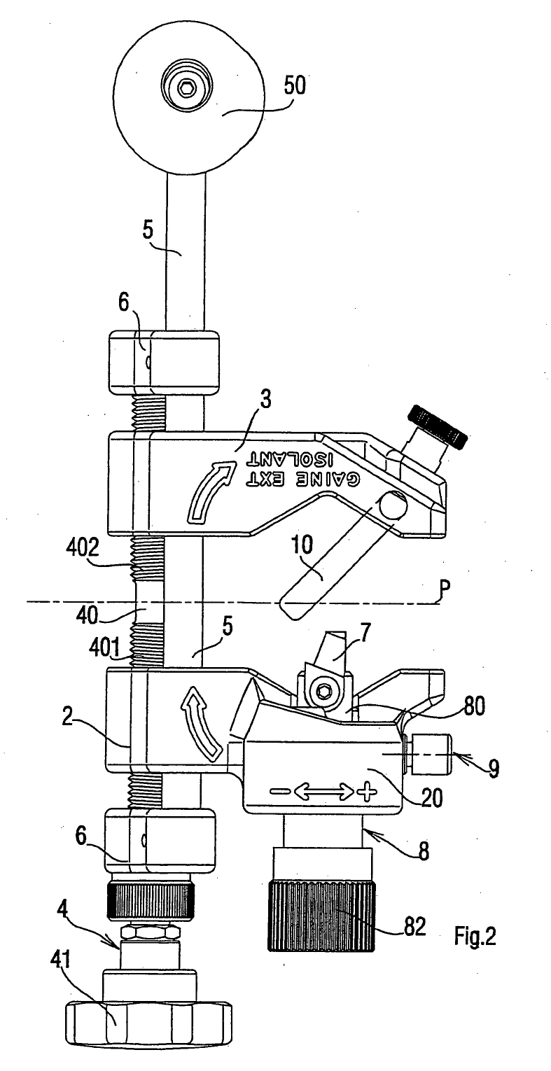

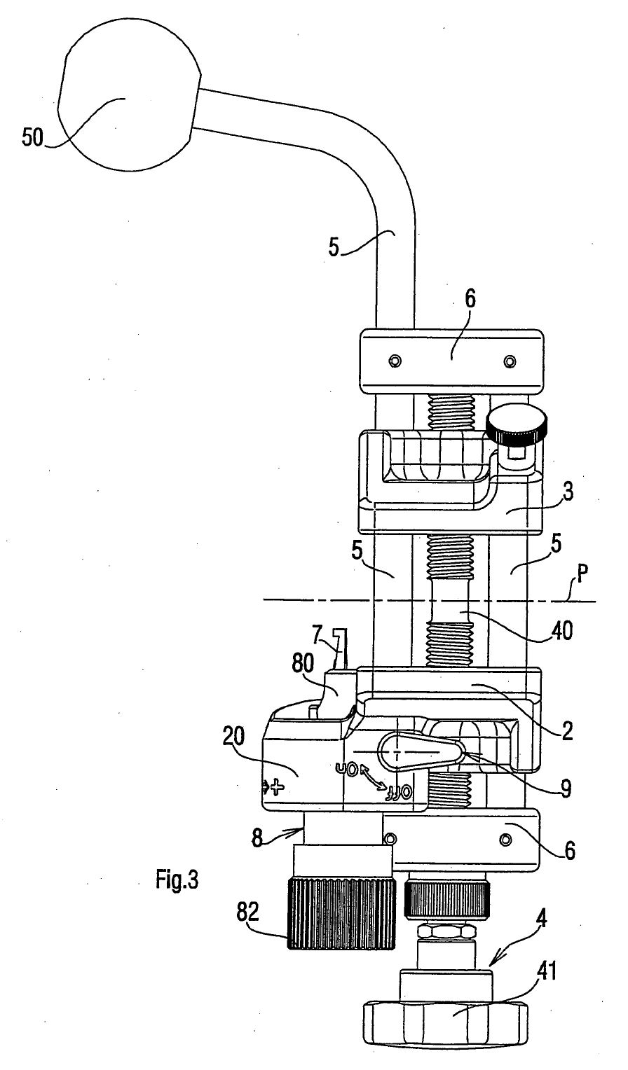

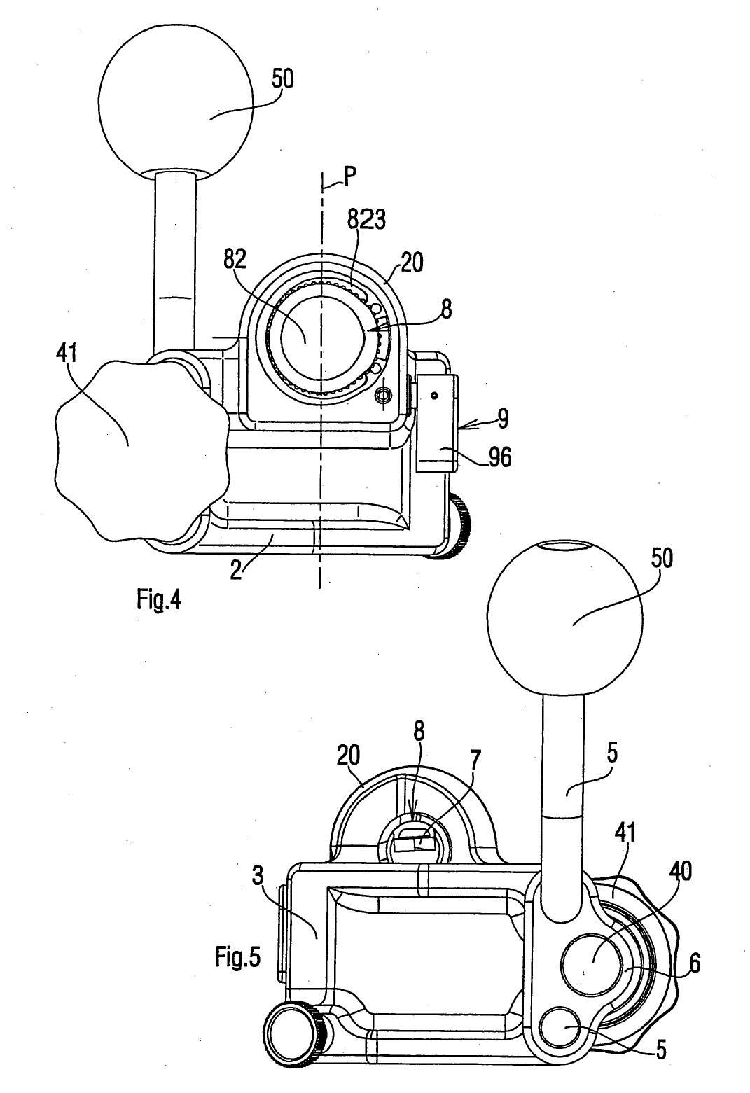

FIGS. 2 to 5 are respectively views from above, from the front, from the left and from the right of a tool according to the first embodiment,

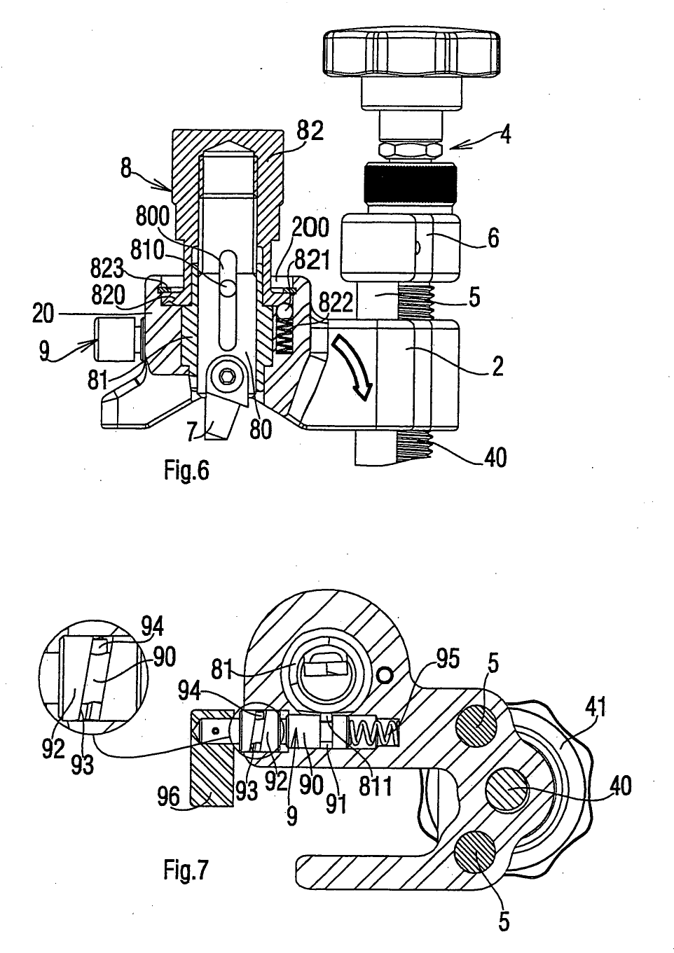

FIG. 6 is a longitudinal cross-sectional view of the adjustment mechanism for the depth of cutting, mounted in the corresponding jaw block,

FIG. 7 is a cross-sectional view of the angular orientation mechanism of the cutting blade mounted in the corresponding jaw block,

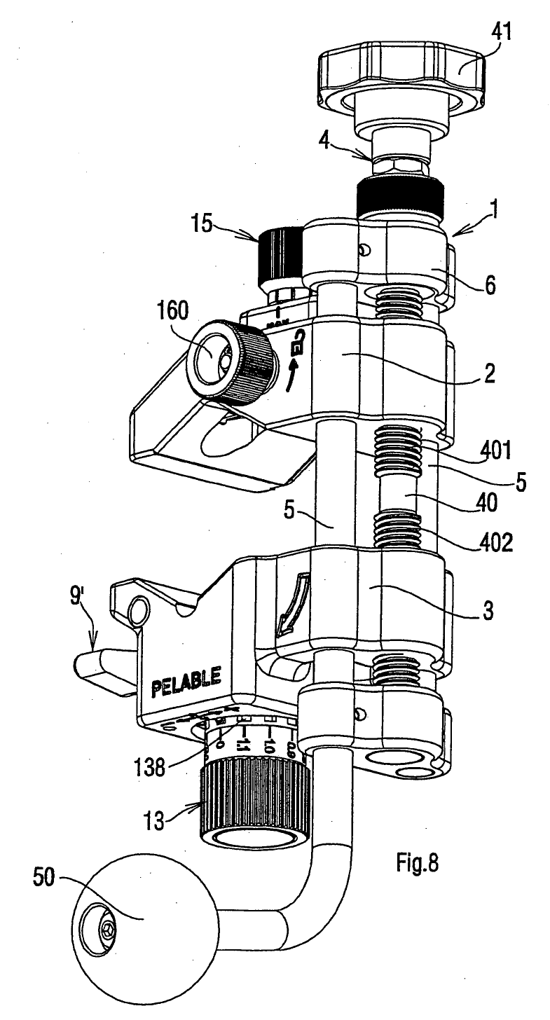

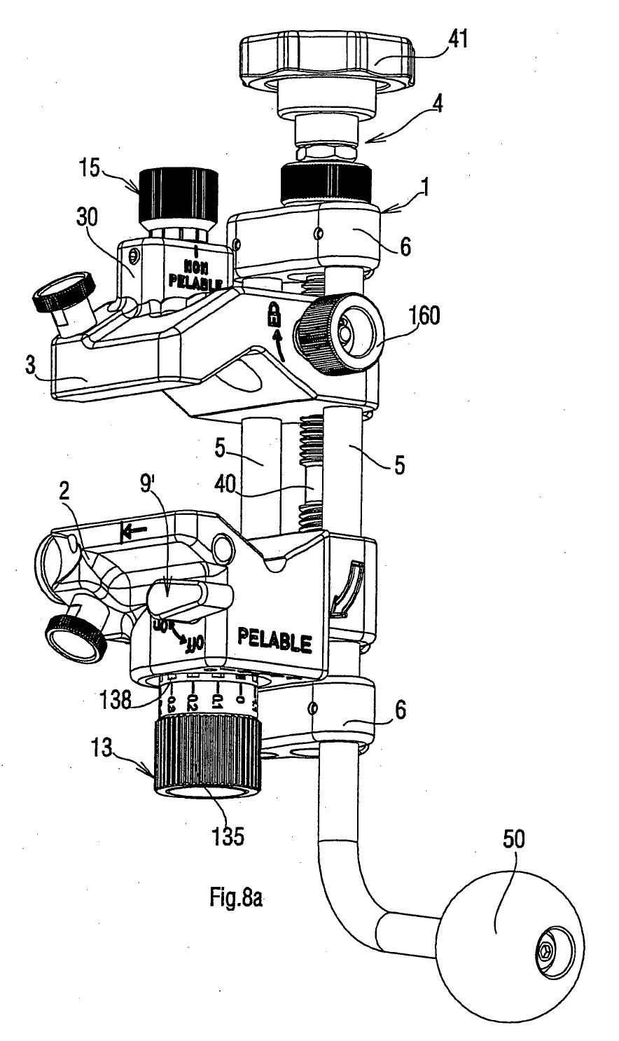

FIG. 8 is a perspective view of a tool according to a second embodiment, specifically adapted for removing peelable and non-peelable semiconductive layers,

FIG. 8a is a perspective view of the tool according to a second embodiment from another angle of view,

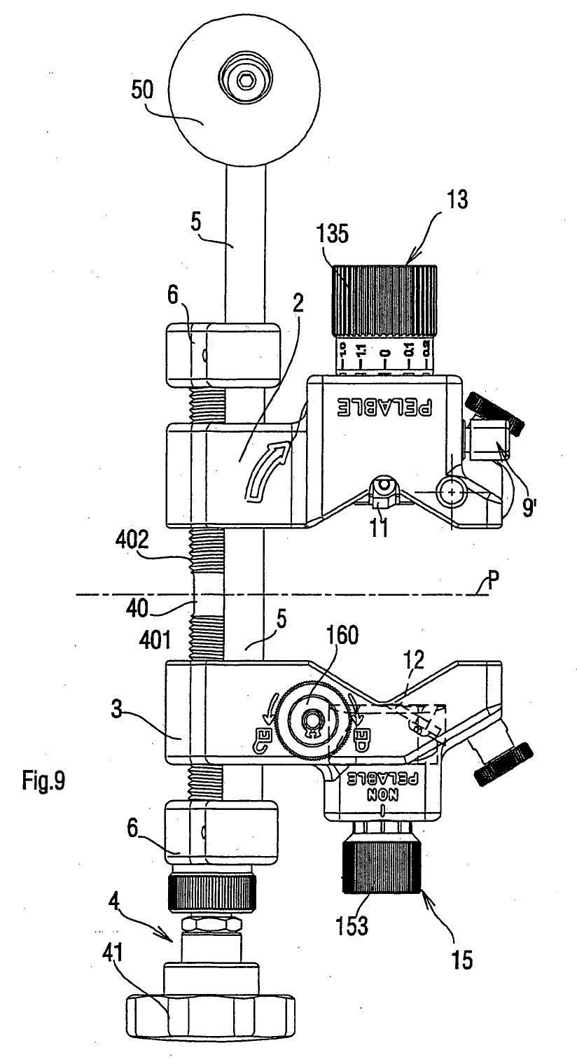

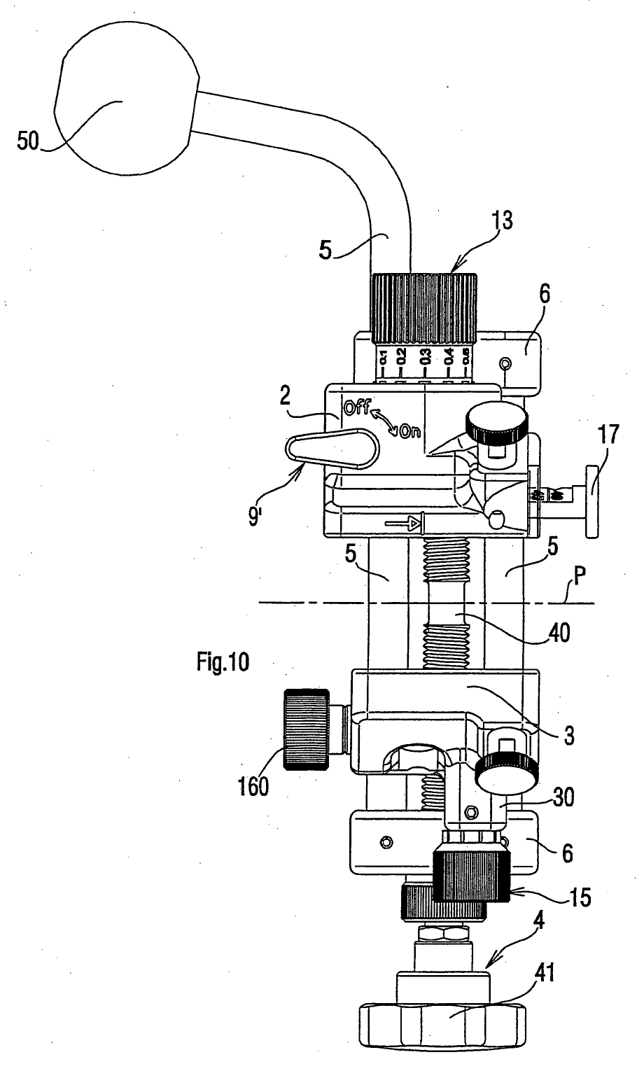

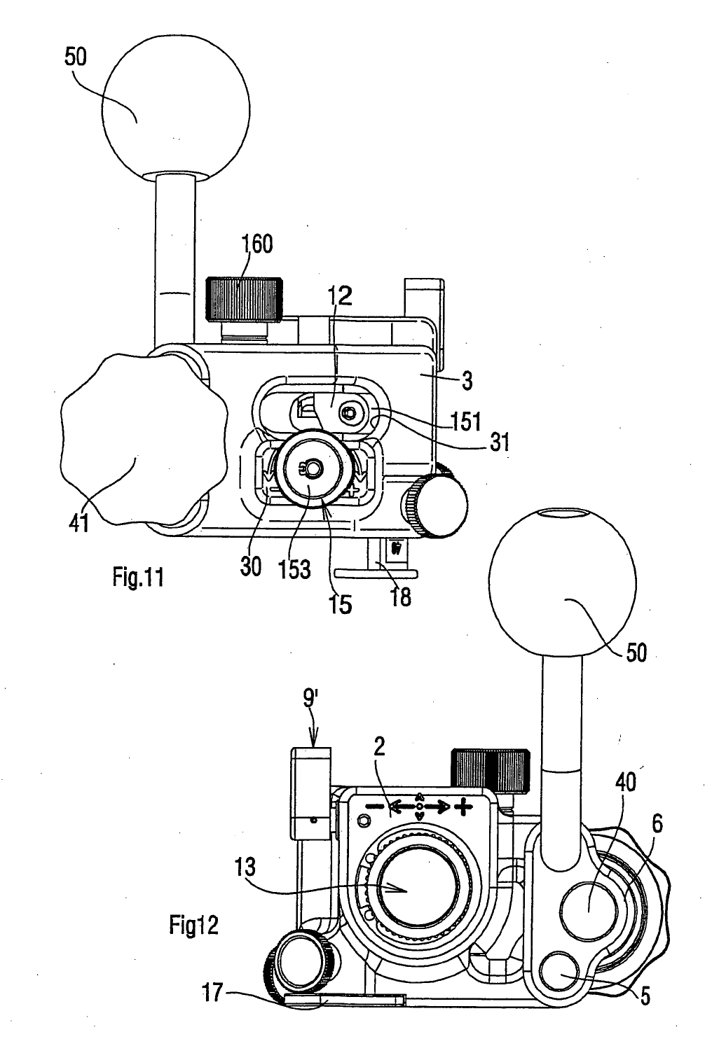

FIGS. 9 to 12 are respectively views from above, from the front, from the left and from the right of the tool according to the second embodiment,

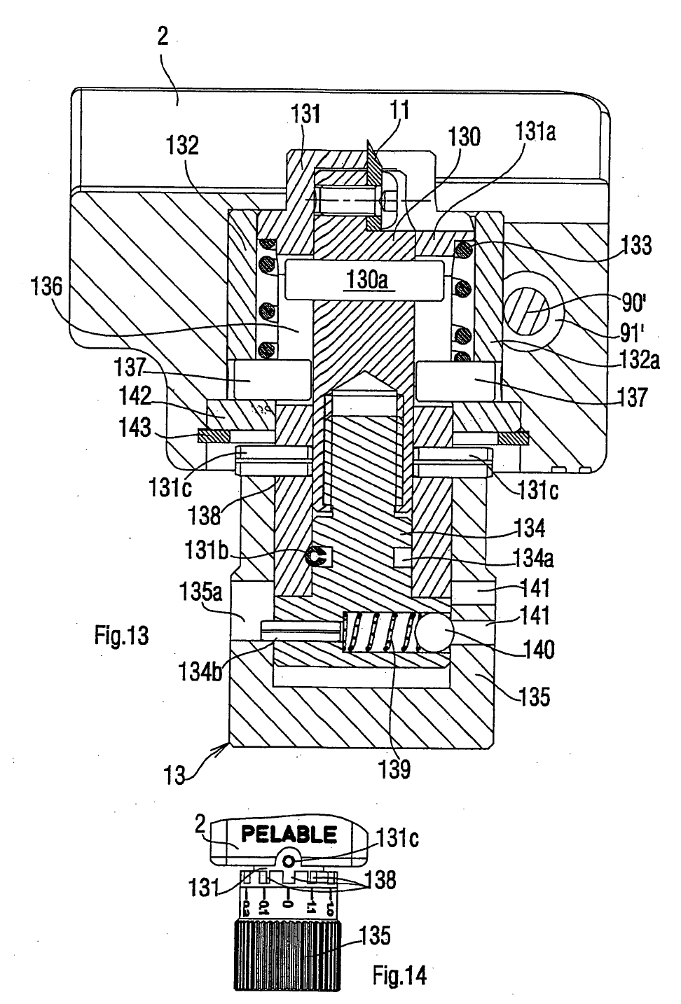

FIG. 13 is a longitudinal cross-sectional view of the adjustment mechanism for the projection of the cutting blade for the peelable semiconductive layer, mounted in it jaw block, the rotor being in locked position

FIG. 14 shows the rotor of this mechanism in unlocked position, for adjusting the projection of the blade,

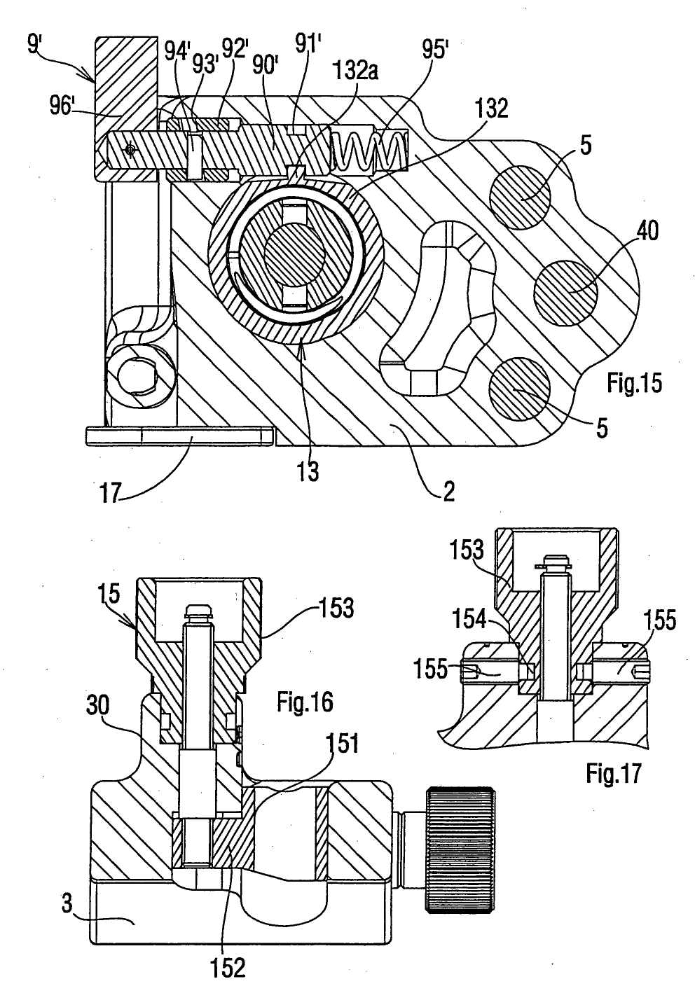

FIG. 15 is a longitudinal cross-sectional view of the angular orientation mechanism for the cutting blade,

FIG. 16 is a longitudinal cross-sectional view of the adjustment mechanism of the depth of cutting of the cutting blade adapted to remove the non-peelable semiconductor layer, mounted in the corresponding jaw block,

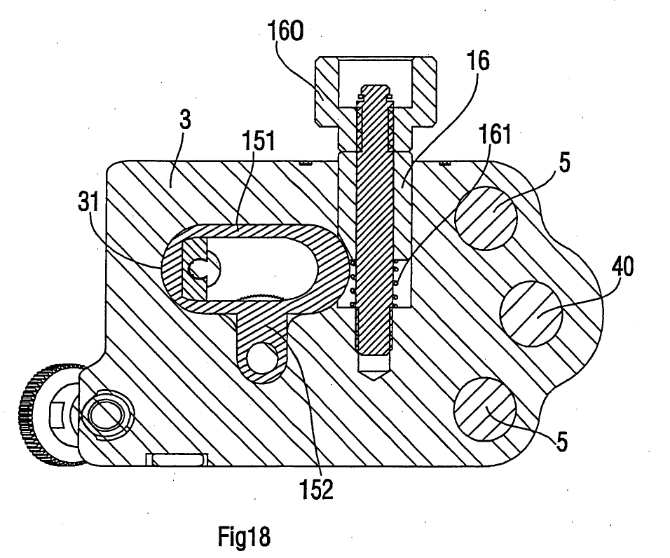

FIG. 17 is a detailed cross-sectional view showing the lockage in translation of the manipulating screw of the adjustment mechanism according to FIG. 16,

FIG. 18 is a transverse cross-sectional view of the jaw block showing the locking member in the locked position.

As shown, the tool according to the invention, for stripping electrical cables, comprises a frame 1 on which are installed in opposition two jaw blocks 2, 3, both coacting with a same mechanism 4 for adjustment of their mutual positions. At least one of the two blocks 2, 3 is provided with a V-shaped groove defining with the other jaw block a recess for a cable to be stripped and at least one of the two blocks 2, 3 is provided with at least one cutting tool which can be one of the type of those designed to cut and/or remove the external insulating sleeve, the external peelable or non-peelable semiconductive layer, the insulating layer and the semiconductor layer of the electrical cable, these operations being carried out by combined rotation and advance of the tool along the cable.

In the preferred embodiment, each jaw block 2, 3 has a V-shaped groove.

According to the invention, the frame 1 comprises two parallel guide columns 5 rigidly interconnected at their ends by two crosspieces 6, each in combination with the two columns 5 define a rigid frame, which cannot be deformed, of rectangular shape.

The two jaw blocks 2, 3 are mounted slidably on the two columns 5 and are disposed symmetrically relative to a median geometric plane P to the frame and orthogonal to the columns 5. The axis of the recess of the cable which defines the V-shaped grooves of the two jaw blocks is parallel to the plane of the rectangle which defines the frame.

The two jaw blocks 2, 3 have substantially the same shapes and substantially equal weights and the two crosspieces also have equal shapes and weights, the center of gravity of the tool lying in the cable recess. There is thus decreased the magnitude of parasitic forces due to poor distribution of the weights, the parasitic forces being a hindrance for the user during manual operation of the tool about the cable.

The guide columns 5, of circular cross-section, are engaged in the holes provided in the crosspieces 5 and are immobilized in these holes by pins.

One of the guide columns 5 has at one of its ends, beyond the corresponding crosspiece 6, a radial extension, forming a crank, provided at the end with a gripping handle 50, in the form of a knob for example, mounted for turning on this extension.

The adjustment mechanism 4 ensures symmetrical movement and symmetrical positioning of the two jaw blocks 2, 3 relative to the plane P and this no matter what their spacing.

This adjustment mechanism 4 comprises a screw-threaded rod 40, carrying at its proximal end a manipulating knob 41. This rod 40 extends parallel to the guide columns 5, is engaged freely in rotation by a smooth cylindrical bearing at a distance from its proximal end, in a proximal bearing mounted fixedly in a through-hole formed in the proximal crosspiece 6. The rod 40 has at a distal end a second smooth bearing by which it is engaged rotatably in a distal bearing mounted fixedly in the hole provided in the distal crosspiece 6.

The screw-threaded rod 40 is immobilized in translation relative to the frame 1 by a first proximal shoulder forming at a distance from its proximal end and provided to come into bearing against the proximal bearing end by a distal shoulder formed at a distance from its distal end and provided to come into bearing against the distal bearing.

On this side of its smooth proximal bearing, the rod 40 comprises a first screw-threaded portion provided to receive a not for blocking in rotation. Behind this first screw-threaded portion is formed on the rod 40 a second screw-threaded portion provided to be engaged in a blind tapping formed in the manipulating knob 41. It should be noted that the manipulating knob 41 of the screw-threaded rod 40 and the gripping handle 50 occupy relative to each other two opposite positions, distant from each other, and that this manipulating knob 41 with the handle 50 is adapted to be gripped by the user to manipulate the tool during stripping the cable.

The rod 40 comprises a first screw-threaded section 401 with a right-hand thread engaged by screwing in a through tapping provided in one of the two jaw blocks, and a second screw-threaded section 402 with a left-hand thread engaged in a through tapping provided in the other jaw block, the two screw-threaded sections being arranged symmetrically relative to the plane P. It follows that the two screw-threaded sections have a pitch of the same value. Preferably, the proximal shoulder is formed at the proximal end of the proximal screw-threaded section and the distal shoulder is formed at the distal end of the distal screw-threaded section of the rod 40.

In FIGS. 1 to 7 is shown a tool according to a first embodiment. One 2 of the two jaw blocks of this tool is provided with a cutting blade 7 shaped to remove the external insulating sleeve of the cable and its aluminum strip and for the removal of the internal insulating layer of the internal semiconductive layer associated with this same cable. The other jaw block 3 which can have a wide central recess, could be provided with a cutting blade adapted for the formation of a chamfer at the end of the insulation.

The cutting blade 7 is mounted removably on an adjustment mechanism 8 for the depth of its cut. This mechanism is mounted in the bore formed in a lateral projection 20 of the jaw block 2. The bore is formed in the projection 20 orthogonally to the longitudinal axis of the recess of the cable and occupies a lateral position relative to one of the ends of the groove.

This adjustment mechanism 8 comprises:
a blade support 80 of cylindrical shape receiving at its forward end, removably, the cutting blade 7 and provided at its rear portion with a screw-threaded section,
a guide sleeve 81, of substantially cylindrical shape, provided along its central geometrical longitudinal axis with an internal cylindrical through bore, receiving freely in translation and fixed in rotation the blade support 80, said blade support 80 passing through from one side to the other of the sleeve 81 and said guide sleeve 81 being engaged freely in rotation in the through bore of the projection 20,
an adjustment wheel 82 provided with an axial tapping to receive the screw-threaded section of the blade support 80, said wheel 82 being engaged in part in the through bore of the projection, and being immobilized in translation in said bore whilst being free in rotation in this latter, such that by rotation of the wheel 82 in one direction or the other, the blade support 80 and the cutting blade 7 will be moved in translation and the blade 7 will be brought to the required position of projection relative to the recess of the cable.

The cutting blade 7, which is present in the form of a small plate, is introduced in the recess formed at the forward end of blade support 80 and is fixed in this recess by a screw. This blade 7 is provided with a bearing heel which will slide on the semiconductive external layer during cutting of the insulating sleeve or on the central conductive core during cutting of the insulating layer.

The blade support 80 is provided with a diametral through oblong opening 800, in which is engaged a through pin 810 engaged at two ends in two through axially aligned holes formed in the wall of the guide sleeve 81. This arrangement ensures the immobilization in rotation on the blade support 80 in the guide sleeve 81 whilst permitting a translation of limited amplitude of said support 80 in said sleeve 81.

Preferably, the adjustment wheel 82 is associated with an indexing means for the various angular positions which it is adapted to take and this means ensuring as a result the indexing of the different corresponding values of projection of the cutting blade relative to the cable recess.

In practice, this indexing means is constituted by a small end collar 820 formed on the wheel and provided with a series of imprints or hollows, for example 12 in number, angularly spaced equally about the circumference of a circle centered on the axis of rotation of the wheel 82 and by a rod 821 urged toward the small collar 820 under the action of a resilient member 822 so as to be engaged in one of the impressions of the small collar, said rod 821 and said resilient member being mounted in a blind hole provided in the lateral projection 20 of the jaw block.

Again according to the preferred embodiment, the small collar 820 of the wheel 82 is engaged in a countersink 200 provided in the bore of the projection 20, and the blind hole provided to receive the rod 821 and its resilient member 822, opens into the flat surface constituting the bottom of this countersink 200.

Behind the position occupied by the small collar 820 in the countersink 200, is formed in this latter a circular throat in which is engaged a spring ring 823. This arrangement ensures the immobilization in translation in the bore of the lateral projection, of the adjustment mechanism for the depth of cutting.

The adjustment wheel 82 could be provided with a reference mark and the projection 20 about the bore could have a graduated scale facing which the reference mark will be located. This arrangement is an advantageous means for indication of the value of projection of the cutting blade into the cable recess.

With the mechanism 8 for adjustment of the depth of cut of the blade 7 is associated a mechanism 9 for orientation of the cutting blade 7, this orientation mechanism acting on the adjustment mechanism 8 so as to bring it, by pivoting in the bore of the lateral projection 20, from a cutting position in helix toward a circular cutting position, and conversely.

For stripping, the blade 7 is disposed in helical cutting position. After performing the helical cut along the length desired to be stripped, this blade 7 is disposed in circular cutting position and by rotation of the tool for one or two turns, the portion of the external sleeve or the portion of the internal insulating layer cut off in a helix will be separated from the cable.

In the preferred embodiment (FIG. 7), the orientation mechanism 9 for the cutting blade 7 acts on a longitudinal projection 811 formed on a longitudinal flat of the drive sleeve 81 and comprises a manipulating axle 90 engaged in rotation in a blind bore provided in the later projection 20 of the jaw block 2 and opening longitudinally into the bore of said projection. The manipulating axle 90 is provided with a circular throat 91 in which is engaged the longitudinal projection 811 of the guide sleeve 81. This manipulating axle 90, at a distance from the throat 91, is engaged freely in rotation and in translation in a ring 92 immobilized in the tangential blind opening. This ring 92 comprises a through groove 93 in the form of a helix, forming a cam, in which is engaged a radially projecting finger 94 fixed to the manipulating axle 90, said manipulating axle 90, externally of the hole which receives it, receiving a manipulating knob 96. The helical groove 93 which comprises the ring 92 constitutes a cam against which will slide the radial finger 93 of the manipulating axle 90. This cam, when the manipulating axle 90 is driven in rotation, by acting on the radial finger 93, forces the axial translation of the manipulating axle in the bore which receives it, which translates into the pivoting, in the bore of the lateral projection 20, of the adjustment mechanism 8 or the depth of cut of the blade.

Preferably, a coil spring 95 whose turns do not touch is mounted in compression between the manipulating axle 90 and the bottom of the blind hole which receives said axle. This arrangement permits holding the projecting finger 93 in bearing against the cam formed by the groove 93.

Preferably at each end of the groove 93 will be formed a recess in which, by return of the manipulating axle 90 under the influence of the spring 95, is engaged the projecting finger 93. The advantage of this arrangement is to form two “hard points” materializing the two possible angular positions of the cutting blade. Moreover, these two hard points are effectively opposed to the random manipulation of the manipulating axle 90.

To limit the length of stripping, one of the two jaw blocks is provided with an adjustable abutment 10 formed by a rod elbowed at the end and engaged adjustably in axial position in a through hole of said block. By its elbowed portion, the abutment, in the course of stripping, is adapted to come against the end of the cable thereby to limit the length of stripping.

In FIGS. 8 to 18 is shown a tool according to a second embodiment. One 2 of the two jaw blocks of this tool is provided with a cutting blade 11 configured for removing the peelable external semiconductive layer and the other jaw block is provided with a cutting blade 12 configured to remove the non-peelable external semiconductive layer. These two cutting blades 11, 12 are adapted to form a projection into the V-shaped groove of their respective jaw blocks and this at a distance from the two ends of said groove. Because of this arrangement, the cable, on opposite sides of the blade 11 or 12, will be located perfectly held centered in the recess by the V-shaped grooves forming this latter, which guarantees a cut of uniform depth. Moreover, the risk is avoided of the insulating layer being damaged by cutting too deep.

It is evident that only the cutting blade provided for the operation to be carried out will be brought into active cutting position, the other cutting blade being held in an inactive position in which it is spaced from the cable.

Preferably, the cutting blade 11, shaped for removing the peelable semiconductive layer, is mounted removably on an adjustment mechanism 13 for the depth of cutting, mounted in a through bore formed in the corresponding jaw block 2, and this orthogonally to the longitudinal axis of the cable recess, said bore opening into the V-shaped groove of said jaw block.

This adjustment mechanism 13 comprises:
a blade support 130 of cylindrical shape receiving at its forward end the cutting blade 11, and provided at its rear end with a blind tapping,
a first guide sleeve 131 provided with an internal cylindrical bore, in which is mounted freely in translation and fixed in rotation the blade support 130,
a second guide sleeve 132, of cylindrical shape, provided with a cylindrical through bore in which is mounted fixedly in rotation and freely in translation the first guide sleeve 131, said second guide sleeve 132 being mounted fixedly in translation and freely in rotation in the through bore of the corresponding jaw block,
a resilient member 133 acting simultaneously on the first guide sleeve 131 and the second guide sleeve 132 and urging these latter in the direction of their mutual spacing,
a manipulating screw 134 engaged by its screw-threaded shank in the tapping of the blade support 130 and blocked in translation in the first guide sleeve 131,
a manipulating knob 135 coupled to the head of the manipulating screw 134.

Thus by rotation of the manipulating knob 134 is adjusted the projection of the cutting blade 11 relative to the forward end of the first guide sleeve 131.

Thanks to these arrangements, the projection of the cutting blade 11 is adjustable essentially relative to the first guide sleeve 131 which by its forward surface, under the action of the resilient member 133, is adapted to come into bearing against the cable. Thus the diameter of the cable no longer interferes with the depth of cut into the cable, this latter no longer depending on anything other than the value of projection of the cutting blade relative to the front surface of the first guide sleeve 131. This projection value is determined by the degree of sinking of the screw shaft 134 into the tapping of the blade support 130.

The cutting blade 11, in the form of a small plate, will be fixed removably by screws in a recess formed in the end of the blade support 130.

In its preferred embodiment, the first guide sleeve 131 is provided with a through opening 136, diametral, of oblong shape, and the cutting blade support 130 is provided with at least one radial pin 130a engaged in the through opening 136 of the first guide sleeve 130.

This arrangement has the effect of ensuring the immobilization in rotation of the blade support 130 in the first guide sleeve 131 and of limiting the amplitude of displacement in translation of the blade support 130 in the first sleeve 131.

The first guide sleeve 131 comprises a small front collar 131a and the second sleeve 132, projecting in its internal bore, has at least one radial pin 137 engaged in the through opening 136 of the first sleeve 131, the resilient member 133 constituted by a coil spring being mounted in compression about the first sleeve 131 between the small collar 131a of this latter and the radial pin 137.

These arrangements ensure the immobilization in rotation of the first guide sleeve 131 and of the second guide sleeve 132 relative to each other, but permit the limited movement in translation of the first sleeve 131 and of the support blade 130 in the bore of the second sleeve 132 and this against the action of the resilient member 133. Preferably, the second guide sleeve has two diametrically opposed radial pins.

The shank of the manipulating screw 134, in front of its head, has a circular throat 134a in which is engaged tangentially a pin 131b engaged moreover in two through holes provided in axial alignment in the first sleeve 131. This arrangement ensures the immobilization in translation of the manipulating screw 134 in the first guide sleeve 131.

The manipulating knob 135 has an internal cylindrical bore and will cap by the internal bore the head of the manipulating screw 134. The head of this screw 134 is provided with a radially projecting finger 134b engaged in an oblong opening 135a provided in the wall of the manipulating knob 135, said opening extending along a generatrix of the bore of the manipulating knob. Because of this arrangement, the manipulating knob 135 and the screw 134 are coupled to each other.

In combination with these characteristics, the manipulating knob 135 has at the front a series of indexing notches 138 forming crenalations and the first guide sleeve 131 has at least one projecting finger 131c, the manipulating knob 135 by engagement with one of these notches 138 about the projecting finger 131c being immobilized in rotation.

For adjustment of the projection of the blade 11, the manipulating knob, by axial movement, is spaced by its notches 138 from the projecting pin 131c and then manipulated in rotation. The screw 134, by virtue of its coupling to the manipulating knob 135, is driven in rotation, which gives to the movement of translation of the cutting blade support 130 in the first sleeve 131. After adjustment of the projection of the cutting blade relative to the front surface of the first guide sleeve 131, the manipulating button 135 by one of its notches 138 and engaged toward the projecting finger 131c to be immobilized in rotation, which reduces the risk of any undesired modification of the adjustment.

Preferably, the head of screw 134 is provided with a radial hole into which are introduced a coil spring 139 and an indexing rod 140 and the wall of the manipulating knob 135 has two radial holes 141 for indexing, spaced apart and formed on a same generatrix.

In the engagement position of one of the notches 138 about the blocking pin 131c, one of the indexing holes 141 comes into facing engagement with the rod 140 to receive this latter, and in the disengagement position, the other indexing hole 141 comes into facing engagement with the rod 140 to receive this latter. There are thereby constituted two hard points forming respectively locking and unlocking positions of the adjustment.

The manipulating knob 135 can comprise a graduated scale, the jaw block 2 facing this graduated scale could comprise a reference mark. This arrangement constitutes an indicia means, by direct reading from the graduated scale, of the value of projection of the cutting blade relative to the front surface of the first guide sleeve 131.

The second guide sleeve 132 is provided with a small rear collar 142 and the through bore of the block has a countersink in which is engaged the small rear collar. The mechanism of adjustment of the depth of cutting is immobilized in the bore of the jaw block by a second spring ring 143 engaged in a groove formed in the countersink behind the position of the small collar 142.

Preferably, there is provided an angular orientation mechanism 9′ for the cutting blade 11, by pivoting the adjustment mechanism 13 in the bore of the jaw block between a helical cutting position of the blade and a circular cutting position. This angular orientation mechanism 9′ is identical to the angular orientation mechanism 9 which according to the first embodiment comprises, the same reference signs but primed will be used to describe it.

According to the preferred embodiment, the orientation mechanism 9′ acts on a longitudinal projection 132a formed on a longitudinal flat of the second guide sleeve 132 and comprises a manipulating axle 90′ engaged in rotation in a blind hole provided in the jaw block 2 and opening tangentially into the bore of this latter. This manipulating axle 90′ is provided with a circular throat 91′ in which is engaged the longitudinal projection 132a of the second guide sleeve 132. This manipulating axle 90′, at a distance from the throat 91′, is engaged freely in rotation and in translation in a ring 92′ immobilized in the tangential blind hole. This ring 92′ comprises a through groove 93′ in the form of a helix, forming a cam, in which is engaged a radially projecting finger 93′ fixed to the manipulating axle 90′, said manipulating axle 90′, externally of the hole which receives it, receiving a manipulating knob 96′. The helical groove 93′ which comprises the ring 92′ constitutes a cam against which the radial finger 93′ of the manipulating axle 90′ will slide. This cam, when the manipulating axle 90′ is driven in rotation, by acting on the radial finger 94′, forces the axially translatory movement of the manipulating axle in the hole which receives it, which is translated by the pivoting of the adjusting mechanism 13, in the bore of the jaw block.

Preferably, a coil spring 95′ with non-touching turns, is mounted in compression between the manipulating axle 90′ and the bottom of the blind hole which receives said axle. This arrangement permits holding the projecting finger 93′ in bearing relation against the cam formed by the groove 93′. Preferably, at each end of the groove 93′, there will be formed a recess in which, by retreat of the manipulating axle 90′ under the influence of the spring 95′, is engaged the projecting finger 94′. The advantage of this arrangement is to form two “hard points” materializing the two possible angular positions of the cutting blade 11. Moreover, these two hard points effectively oppose the random manipulation of the manipulating axle 90′.

The cutting blade 12, configured for removing the non-peelable semiconductor layer, carried by the second jaw block 3, is removably mounted on a mechanism 15 for adjustment of the depth of cut. This mechanism comprises a blade support 151 removably receiving the cutting blade 12 and having a cross-section of substantially oblong shape. This support 151 is engaged with the possibility of sliding in a through hole 31 provided in the corresponding jaw block 3 and opening into the V-shaped groove. This blade support 151 is provided with a tapping, provided in a longitudinal projection 152 which it has on the lower portion. This longitudinal projection 152 is engaged in a throat provided in the jaw block so as to open into the V-shaped groove and into the through hole. A manipulating screw 153 is engaged by its screw thread first of all in a through hole provided in a rear projection 30 of the jaw block 3, and then in the tapping of the blade support 151, said screw 153 being blocked in translation relative to the jaw block 3.

The cutting blade 12 is present in the form of a small plate. This cutting blade is engaged in a recess provided in the blade support 151 and is fixed immovably by a screw in this recess.

This screw 153 adjacent its head, on the shank, has a circular throat 154 in which is engaged at least one screw 154 engaged in a radial tapping provided in the projection 30.

The screw 153 can have a graduated scale and the rear projection 30 can comprise a reference mark. This arrangement will constitute an indicia means for direct reading, of the value of the projection of the cutting blade 12, into the cable recess.

Preferably a second jaw block 3 is provided with a member 16 for blocking in rotation the blade support 151. This blocking member 16 can occupy an unlocked position, according to which it is spaced from the support of the blade 151 and a locked position according to which it is applied against the blade support 151 to prevent movement of this latter. This blocking member 16 is mounted slidably in a bore formed in the jaw block 3 and opening tangentially into the guide hole of the blade support 151, said blocking member 16 being provided with a through hole in which is engaged the shank of a screw 160 engaged in a tapping formed in the jaw block. Moreover, there is provided a resilient member 161 which urges the blockage member 16 toward the screw head 161.

By screwing, the head of the screw 160 is applied to the blocking member 16 against the blade support 151, and during unscrewing of the screw 160, the blocking member 16 is brought toward its unlocking position on the influence of the action of the elastic member 161 which holds it against the head of the screw.

This resilient member 161 is constituted by a spiral spring mounted about the screw, in compression between the blocking member 16 and the bottom of the bore receiving this member.

Finally, the two jaw blocks 2, 3 are each provided with an adjustable abutment 17, 18 to limit the length of cut, each abutment 17, 18 being constituted by a flat small plate carried transversely to the recess of the cable by a support axle engaged slidably in a hole provided in the corresponding jaw block, said axle cooperating in said bore with a rod indexing mechanism.

It follows that the present invention can be the subject of all arrangements and variations in the field of technical equivalents without thereby departing from the scope of the present patent.

1. Tool for stripping electrical cables comprising a frame (1) on which are installed two jaw blocks (2, 3) both coacting with a same mechanism (4) for regulating their mutual positions, at least one of the two blocks being provided with a V-shaped groove defining with the other jaw block a recess for the cable to be stripped and at least one of the two blocks being provided with at least one cutting tool, characterized in that:
the frame (1) comprises two parallel columns (5) rigidly connected at their ends by two crosspieces (6), these two columns (5) and these two crosspieces (6) forming a rigid framework,
the two jaw blocks (2, 3) are mounted slidably on the two columns (5) and are disposed symmetrically relative to a central geometric plane (P) of the frame and orthogonal to the columns (5) of this latter,
the two jaw blocks (2, 3) are disposed both on the same side of the framework defined by the two columns (5) and the two crosspieces (6),
and the mechanism (4) for regulating the position of the two jaw blocks which ensures a symmetrical positioning of the two jaws relative to the geometric plane defined above, comprises a screw-threaded rod (40) with a manipulating knob, (41) extending parallel to the columns (5) between the two crosspieces (6), said screw-threaded rod (40) being immobilized in translation and movable in rotation relative to the frame (1) and comprising a first screw-threaded section (401) with a right-hand thread, engaged screw-threadedly in a through tapping provided in one of the jaw blocks (,3) and a second screw-threaded section (402) with a left-hand thread and of the same value as the pitch of the preceding section, said second screw-threaded section (402) being engaged in a through tapping provided in the other jaw block (2, 3).

2. Tool according to claim 1 characterized in that one (2) of the two jaw blocks (2, 3) is provided with a cutting blade (7) and that this cutting blade (7) is configured for removing the external insulating sleeve from the cable and its aluminum strip and for the removal of the insulating layer of the cable and of the associated internal semiconductive layer.

3. Tool according to claim 2, characterized in that the other jaw block is provided with a cutting blade adapted for the formation of a chamfer at the end of the insulation.

4. Tool according to claim 2, characterized in that the cutting blade configured for removing the external insulating sleeve and its aluminum strip and for the removal of the insulating layer with the semiconductive insulating layer is mounted removably on a mechanism (8) for adjustment of the depth of cutting, comprising:
a blade support (80) of cylindrical shape receiving at its forward end, removably, the cutting blade (7), and provided at its rear portion with a screw-threaded section,
a guide sleeve (81), substantially of cylindrical form, provided on its geometric central longitudinal axis with an internal cylindrical through bore, receiving freely in translation and fixed in rotation the blade support (80), said blade support (80) passing through from end to end of the guide sleeve (81) and said drive sleeve (81) being engaged freely in rotation in the through bore of a projection (20) formed on the corresponding jaw block (2) and extending laterally to the V-shaped groove of this jaw block,
an adjustment wheel (82) provided with axial screw threading provided to receive the screw-threaded section of the blade support (80), said wheel being engaged in part in the through bore of the projection (20), and being immobilized in translation in said bore and free in translation in this latter, such that by rotation of the wheel (82) in one direction or the other, the blade support (80) and the cutting blade (7) will be moved in translation and the blade (7) will be brought to the required position of projection relative to the cable recess.

5. Tool according to claim 4, characterized in that the adjustment wheel (82) is associated with an index means for the various angular positions that it is to take up and accordingly for indexing the different values of corresponding projection of the cutting blade relative to the cable recess.

6. Tool according to claim 5, characterized in that the indexing means associated with the adjustment wheel (82) is constituted by a small end collar (820) formed on the wheel (82) and provided with a series of hollow impressions, angularly spaced equally about the circumference of a circle centered on the axis of rotation of the wheel (82) and by a rod (820) urged toward the small collar under the influence of the action of a resilient member so as to be engaged in one of the impressions of the small collar (820), said rod (821) and said elastic member (822) being mounted in a blind hole provided in the projection (20).

7. Tool according to claim 6, characterized in that the small collar (820) of the wheel (82) is engaged in a countersink (200) provided in the bore of the projection (20), that the blind hole provided to receive the rod (821) and its resilient member (822) opens into the flat surface constituting the bottom of this countersink (200) and in that behind the position occupied by the small collar (820) in the countersink (200), is formed in this latter a circular throat in which is engaged a spring ring (823) ensuring the immobilization in translation in the bore (200) of the lateral projection, of the mechanism (8) for adjustment of the depth of cutting.

8. Tool according to claim 4, characterized in that the cutting blade support is provided with an oblong through diametral opening (800) in which is disposed a cross pin engaged by its two ends in two through holes axially aligned and formed in the wall of the sleeve.

9. Tool according to claim 4, characterized by a mechanism (9) for angular orientation of the cutting blade (7), this orientation mechanism (9) acting on the adjustment mechanism (8) so as to provide, by pivoting in the bore of the lateral projection (20), a helical cutting position toward a circular cutting position and vice versa.

10. Tool according to claim 9, characterized in that the orientation mechanism (9) of the cutting blade acts on a longitudinal projection (811) formed on a longitudinal flat of the guide sleeve (81) and comprises a manipulating axle (90) engaged in rotation in a blind hole provided in the lateral projection (20) and opening tangentially into the bore of this latter, said manipulating axle (90) being provided with a circular throat (91) in which is engaged the longitudinal projection (811) of the guide sleeve (81), said manipulating axle (90), at a distance from the throat (91) being engaged in a ring (92) immobilized in the blind tangential hole, said ring comprising a through groove (93) in the form of a helix, forming a cam, in which is engaged a radial projecting finger (94) fixed to the manipulating axle (90), said manipulating axle, externally of the hole which receives it, receiving a manipulating knob (96).

11. Tool according to claim 10, characterized by a spring with spaced coils (95) mounted in compression between the manipulating axle (90) and the bottom of the blind tangential hole which receives it and in that the groove (93) comprises at each end a recess in which, by return of the manipulating axle (90) and of the action of the spring (95), is engaged the projecting finger (94).

12. Tool according to claim 2, characterized in that one of the jaw blocks is provided with an adjustable abutment (10) to limit the length of stripping, formed by a rod elbowed at its end and engaged adjustably as to axial position in a through hole of said block.

13. Cutting tool according to claim 1, characterized in that one (2) of the two jaw blocks is provided with a cutting blade configured for removal of the peelable external semiconductor layer and that the other jaw block (3) is provided with a cutting blade (12) configured for the removal of the non-peelable external semiconductor layer, said cutting blades (11, 12) being adapted to project into the V-shaped groove of their respective jaw block.

14. Tool according to claim 13, characterized in that the cutting blade (11) configured to remove the peelable semiconductive layer is mounted removably on a mechanism (13) for adjusting the depth of cut, mounted in a through bore formed in the jaw block (2) and this orthogonally to the longitudinal axis of the cable recess, said bore opening into the V-shaped groove of said jaw block and said mechanism (13) comprising:
a blade support (130), of cylindrical shape, receiving in its forward end the cutting blade (11), and provided in its rear end with a blind tapping,
a first guide sleeve (131) provided with an internal cylindrical bore in which is mounted freely in translation and fixed in rotation the blade support (130),
a second guide sleeve (13), of cylindrical form, provided with a cylindrical through bore in which is mounted fixedly in rotation and free in translation the first guide sleeve (131), said second guide sleeve (132) being mounted in a manner fixed in translation and free in rotation in the through bore of the corresponding jaw block,
an elastic member (133) acting simultaneously on the first guide sleeve (131) and the second guide sleeve (132) and urging these latter in the direction of their mutual spacing,
a manipulating screw (134) engaged by its screw thread in the tapping of the blade support (130) and blocked in translation in the first guide sleeve (131),
a manipulating knob (135) coupled to the head of the manipulating screw (134), such that by rotation of the manipulating knob 134 will be adjusted the projection of the cutting blade (11) relative to the forward end of the first guide sleeve (131).

15. Tool according to claim 14, characterized in that the first guide sleeve (131) is provided with a through opening (136), diametral, of oblong shape, and that the support of the cutting blade (130) is provided with at least one radial pin (130a) engaged in the through opening (136) of the first guide sleeve (130).

16. Tool according to claim 14, characterized in that the first guide sleeve (131) comprises a small forward collar (131a), that the second guide sleeve (132), projecting in its internal bore, has at least one radial pin (137) engaged in the through opening (136) of the first guide sleeve (131) and that the resilient member (133) constituted by a coil spring is mounted in compression about the first sleeve (131) between the small collar (131a) of this latter and the radial pin (137).

17. Tool according to claim 13, characterized in that the shank of the manipulating screw (134) in front of its head has a circular throat (134a) in which is engaged tangentially a pin (131b) engaged in the two through holes provided in axial alignment in the first guide sleeve (131).

18. Tool according to claim 13, characterized in that the manipulating knob (135) has an internal cylindrical bore and caps, by its internal bore, the head of the screw (135) is provided with a projecting radial finger (134b) engaged in an oblong opening (135a) provided in the wall of the manipulating knob (135), and extending along a generatrix of the bore of the manipulating knob (135), at said manipulating knob (135) has at the front a series of indexing notches (138) forming crenalations and that the first guide sleeve (131) has at least one projecting finger (131c), the manipulating know (135) by engagement with one of its notches (138) about the projecting finger being immobilized in rotation.

19. Tool according to claim 18, characterized in that the head of the screw (134) is provided with a radial hole in which are introduced a coil spring (139) and an indexing rod (140) and that the wall of the manipulating knob (135) has two radial indexing holes (141) spaced from each other and formed along a same generatrix, in the position of engagement of one of the notches (138) about the blocking pin (131c) one of the indexing holes (141) confronting the rod (140) to receive this latter, and in the position of disengagement the other indexing hole (141) facing the rod (140) to receive this latter.

20. Tool according to claim 13, characterized in that the second support is provided with a rear small collar (142), that the through bore of the block has a countersink in which is engaged in the small rear collar (142) and that the mechanism (13) for adjustment of the depth of cut is immobilized in the bore of the jaw block by a spring ring (143) engaged in a groove formed in the countersink behind the position of the small collar (142).

21. Tool according to claim 13, characterized by a mechanism (9′) for angular orientation of the cutting blade, this orientation mechanism (9′) acting on the adjusting mechanism (13) so as to bring, by pivoting in the bore of the jaw block from one cutting position in a helix toward one position of circular cutting, and vice versa.

22. Tool according to claim 21, characterized in that the orientation mechanism (9′) of the cutting blade acts on a longitudinal projection (132a) formed on a longitudinal flat of the second guide sleeve (132) and comprises a manipulating axle (90′) engaged in rotation in a blind hole provided in the jaw block (2) and opening tangentially into the bore of this latter, said manipulating axle (90′) being provided with a circular throat (91′) in which is engaged the longitudinal projection (132a) of the second guide sleeve (132), said manipulating axle (90′), at a distance from the throat (91′) being engaged in a ring (92′) immobilized in the tangential blind hole, said ring comprising a through groove (93′) in the form of a helix, forming a cam, in which is engaged a radially projecting finger (94′) fixed to the manipulating axle (90′), said manipulating axle, externally of the hole that receives it, receiving a manipulating knob (96′).

23. Tool according to claim 22, characterized by a coil spring with spaced turns (95′) mounted in compression between the manipulating axle (90′) and the bottom of the blind tangential hole which receives it, and that the groove (93′) comprises at each end a recess in which, by return of the manipulating axle (90′) under the action of the spring (95′), is engaged the projecting finger (94′).

24. Tool according to claim 13, characterized in that the cutting blade (12) configured for removal of the non-peelable semiconductive layer, is mounted removably on a mechanism (15) for adjustment of the depth of cut, comprising a blade support (151) having a cross-section substantially of oblong shape, said support receiving removably the cutting blade, and being engaged with the possibility of sliding in a through hole (31) provided in the corresponding jaw block (3) and opening into the V-shaped groove, said blade support (151) being provided with a tapping, provided in a slender projection (152), which it has in its lower portion, said slender projection (152) being engaged in a throat provided in the jaw block so as to open into the V-shaped groove and into the through hole (31) and a manipulating screw (160) engaged by its screw-threaded shaft first in a through hole provided in a rear projection (30) of the jaw block (3) and then in the blade support tapping (151), said screw (160) being blocked in translation relative to the jaw block (3).

25. Tool according to claim 24, characterized by a blocking member (16) of the blade support (151) in translation.

26. Tool according to claim 13, characterized in that the two jaw blocks (2, 3) are each provided with an adjustable abutment (17, 18) to limit the length of cutting, each abutment (17, 18) being constituted by a small flat plate carried transversely to the cable recess by a support axle engaged slidably in a hole provided in the corresponding jaw block, said axle coacting in said bore with a ball indexing mechanism.

27. Set of tools for readying the ends of cables for their electrical connection, characterized in that it comprises a first tool according to claim 1 wherein one (2) of the two jaw blocks (2, 3) is provided with a cutting blade (7) and that this cutting blade (7) is configured for removing the external insulating sleeve from the cable and its aluminum strip and for the removal of the insulating layer of the cable and of the associated internal semiconductive layer
and a second tool according to claim 1 wherein one (2) of the two jaw blocks is provided with a cutting blade configured for removal of the peelable external semiconductor layer and that the other jaw block (3) is provided with a cutting blade (12) configured for the removal of the non-peelable external semiconductor layer, said cutting blades (11, 12) being adapted to project into the V-shaped groove of their respective jaw block.
